(19) United States
(12) Patent Application Publication
(10) Pub. No.: US 2024/0222651 A1
(43) Pub. Date: Jul. 4, 2024

(54) OXYGEN EVOLUTION CATALYST HAVING CORE-SHELL STRUCTURE INCLUDING IRIDIUM OXIDE AND RUTHENIUM OXIDE, AND METHOD OF PREPARING SAME

(71) Applicants: Hyundai Motor Company, Seoul (KR); Kia Corporation, Seoul (KR); Korea University Research and Business Foundation, Seoul (KR)

(72) Inventors: Dae Yong Son, Seoul (KR); Jong Kil Oh, Yongin-si (KR); Kwang Yeol Lee, Seoul (KR); Ye Ji Park, Seoul (KR); Duck Hyun Kim, Seoul (KR)

(21) Appl. No.: 18/328,908

(22) Filed: Jun. 5, 2023

(30) Foreign Application Priority Data
Dec. 29, 2022 (KR) 10-2022-0189295

(51) Int. Cl. H01M 4/92

(52) U.S. Cl. CPC H01M 4/921

(57) ABSTRACT

Disclosed is an oxygen evolution catalyst having a core-shell structure including iridium oxide and ruthenium oxide and a method of preparing the same. More particularly, the method of preparing an oxygen evolution catalyst includes preparing a core including nickel sulfide, manufacturing nanoparticles by allowing a coating layer including iridium and ruthenium to grow on the surface of the core, and obtaining a catalyst by heat-treating the nanoparticles, in which the catalyst includes the core and a shell surrounding the surface of the core and including iridium oxide and ruthenium oxide.

### CROSS-REFERENCE TO RELATED APPLICATIONS

This application claims, under 35 U.S.C. § 119(a), the benefit of priority from Korean Patent Application No. 10-2022-0189295, filed on Dec. 29, 2022, the entire contents of which are incorporated herein by reference.

### TECHNICAL FIELD

The present disclosure relates to an oxygen evolution catalyst having a core-shell structure including lithium oxide and ruthenium oxide and a method of preparing the same.

### BACKGROUND

With an increase in energy demand worldwide, the problem of climate change caused by the use of fossil fuels is becoming more serious. As an alternative energy to solve these problems, hydrogen that may be stored in a fuel form is the most promising fuel candidate.

However, water electrolysis technology, which is important in hydrogen production, still has difficulties in demonstration and commercialization. In particular, oxygen evolution reaction (OER) that occurs at the anode during water electrolysis involves movement of many electrons and the reaction rate is low. In order to maximize the performance of water electrolysis devices, it is essential to develop oxygen evolution reaction (OER) catalysts having high performance and high durability.

In water electrolysis, OER is known to have a very low reaction rate because many electrons move at the same time. Therefore, in order to increase the performance of the overall water electrolysis reaction, it is essential to develop a catalyst with high performance, high durability, and low cost that may promote OER at the anode.

Furthermore, since the operating environment of polymer electrolyte membrane water electrolysis (PEMWE) is acidic, a catalyst capable of maintaining the structure thereof even under acidic conditions is required for practical industrial application.

Meanwhile, catalysts based on noble metal materials such as iridium currently show the greatest activity and stability in OER, but have a big problem in view of price competitiveness.

### SUMMARY

An object of the present disclosure is to provide a method of preparing an oxygen evolution catalyst that is superior while having price competitiveness by lowering the loading of iridium.

The objects of the present disclosure are not limited to the foregoing. The objects of the present disclosure will be able to be clearly understood through the following description and to be realized by the means described in the claims and combinations thereof.

The present disclosure provides an oxygen evolution catalyst, including a core including nickel sulfide and a shell surrounding a surface of the core and including iridium oxide and ruthenium oxide.

The core may have a shape of a polyhedral prism.

The shell may include a first layer surrounding the core and including ruthenium oxide and a second layer surrounding the first layer and including iridium oxide.

The shell may be an alloy including an oxide of an alloy of iridium and ruthenium.

The shell may include a first layer surrounding the core and including iridium oxide and a second layer surrounding the first layer and including ruthenium oxide.

In addition, the present disclosure provides a fuel cell including the oxygen evolution catalyst as described above.

In addition, the present disclosure provides a method of preparing an oxygen evolution catalyst, including preparing a core including nickel sulfide, manufacturing nanoparticles by allowing a coating layer including iridium and ruthenium to grow on a surface of the core, and obtaining a catalyst by heat-treating the nanoparticles, in which the catalyst includes the core and a shell surrounding a surface of the core and including iridium oxide and ruthenium oxide.

Here, preparing the core may include preparing a first mixture by mixing a nickel precursor and a sulfide precursor, forming a first reaction material by heat-treating the first mixture in an argon atmosphere, and preparing a nickel sulfide precursor using centrifugation after addition of a solvent to the first reaction material.

The nickel sulfide precursor may have a shape of a polyhedral prism having a diameter of 10 to 15 nm and a length of 60 to 70 nm.

Also, preparing the core may include preparing a first mixture by mixing a nickel precursor and a sulfide precursor, forming a first reaction material by heat-treating the first mixture in an argon atmosphere, preparing a second mixture by injecting an iridium precursor to the first reaction material, forming a second reaction material by heat-treating the second mixture in an argon atmosphere, and preparing a nickel sulfide precursor using centrifugation after addition of a solvent to the second reaction material.

The nickel sulfide precursor may have a shape of a polyhedral prism having a diameter of 15 to 20 nm and a length of 60 to 70 nm, a surface of which is doped with iridium.

Also, preparing the core may include preparing a first mixture by mixing a nickel precursor and a sulfide precursor, forming a first reaction material by heat-treating the first mixture in an argon atmosphere, preparing an intermediate using centrifugation after addition of a solvent to the first reaction material, preparing a third mixture by injecting an iridium precursor to the intermediate, forming a third reaction material by heat-treating the third mixture in an argon atmosphere, and preparing a nickel sulfide precursor using centrifugation after addition of a solvent to the third reaction material.

The nickel sulfide precursor may have a shape of a polyhedral prism having a diameter of 10 to 15 nm and a length of 60 to 70 nm, both ends of which are capped with iridium.

In the method, manufacturing the nanoparticles may include mixing the nickel sulfide precursor and at least one selected from the group consisting of an iridium precursor, a ruthenium precursor, and a combination thereof, allowing iridium and ruthenium to grow on a surface of the nickel sulfide precursor by heat-treating a mixture in an argon atmosphere, and manufacturing nanoparticles in powder form using centrifugation after addition of a solvent to a result after growth of iridium and ruthenium.

In the method, obtaining the catalyst may be performed for 30 minutes to 120 minutes under oxygen conditions at a temperature of 350 to 450° C.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1A shows an oxygen evolution catalyst according to a first embodiment of the present disclosure;

FIG. 1B shows a cross-sectional view of the oxygen evolution catalyst according to the first embodiment;

FIG. 2A shows an oxygen evolution catalyst according to a second embodiment of the present disclosure;

FIG. 2B shows a cross-sectional view of the oxygen evolution catalyst according to the second embodiment;

FIG. 3A shows an oxygen evolution catalyst according to a third embodiment of the present disclosure;

FIG. 3B shows a cross-sectional view of the oxygen evolution catalyst according to the third embodiment;

FIG. 4 is a flowchart showing a process of preparing the oxygen evolution catalyst according to the present disclosure;

FIG. 5 schematically shows the shapes of the cores used in the first to third embodiments of the present disclosure;

FIG. 6A shows a transmission electron microscopy (TEM) image of the NiₓS_{y} precursor according to Example 1;

FIG. 6B shows a TEM image of the Ir-doped NiₓS_{y} precursor according to Example 2;

FIG. 6C shows a TEM image of the Ir-capped NiₓS_{y} precursor according to Example 3;

FIG. 7 shows results of X-ray diffraction of the NiₓS_{y} precursor according to Example 1 and the Ir-doped NiₓS_{y} according to Example 2;

FIG. 8 shows results of energy dispersive X-ray spectroscopy (EDX) of Ir-doped NiₓS_{y} according to Example 2;

FIG. 9 shows an EDX mapping image of Ir-doped NiₓS_{y} according to Example 2;

FIG. 10A shows a TEM image of the NiₓS_{y}@Ru@Ir catalyst according to Example 1;

FIG. 10B shows a TEM image of the NiₓS_{y}@RuIr catalyst according to Example 2;

FIG. 10C shows a TEM image of the NiₓS_{y}@Ir@Ru catalyst according to Example 3;

FIG. 11 shows results of X-ray diffraction of the catalysts according to Examples 1 to 3;

FIGS. 12A and 12B show results of energy dispersive X-ray spectroscopy (EDX) of the catalyst according to Example 1;

FIGS. 13A and 13B show results of energy dispersive X-ray spectroscopy (EDX) of the catalyst according to Example 2;

FIG. 13C shows an EDX mapping image of the catalyst according to Example 2;

FIG. 14 show results of energy dispersive X-ray spectroscopy (EDX) of the catalyst according to Example 3;

FIG. 15A shows a TEM image of the NiₓS_{y}@Ru@Ir-A catalyst subjected to thermal oxidation according to Example 1;

FIG. 15B shows a TEM image of the NiₓS_{y}@Ru—Ir-A catalyst subjected to thermal oxidation according to Example 2;

FIG. 15C shows a TEM image of the NiₓS_{y}@Ir@Ru-A anode catalyst subjected to thermal oxidation according to Example 3;

FIG. 16 shows results of X-ray diffraction of the catalysts subjected to thermal oxidation at a high temperature according to Examples;

FIGS. 17A and 17B show results of energy dispersive X-ray spectroscopy (EDX) of the catalyst subjected to thermal oxidation according to Example 1;

FIGS. 18A and 18C show results of energy dispersive X-ray spectroscopy (EDX) of the catalyst subjected to thermal oxidation according to Example 2;

FIG. 18B shows an EDX mapping image of the catalyst subjected to thermal oxidation according to Example 2;

FIGS. 19A and 19B show results of energy dispersive X-ray spectroscopy (EDX) of the catalyst subjected to thermal oxidation according to Example 3;

FIG. 20 shows results of XPS of Ru in the catalysts subjected to thermal oxidation according to Examples;

FIG. 21 shows results of XPS of Ir in the catalysts subjected to thermal oxidation according to Examples;

FIG. 22A shows OER polarization curves of electrodes manufactured by applying anode catalysts after thermal oxidation according to Examples and commercial catalysts;

FIG. 22B shows OER polarization curves of electrodes manufactured by applying anode catalysts before thermal oxidation according to Examples and commercial catalysts;

FIG. 23 shows a chronopotentiometric curve of the NiₓS_{y}@Ru—Ir-A catalyst subjected to thermal oxidation according to Example 2; and

FIG. 24 shows results of evaluation of a cell to which the catalyst according to the second embodiment is applied.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

An aspect of the present disclosure pertains to an oxygen evolution catalyst having a core-shell structure including iridium oxide and ruthenium oxide.

Before describing the catalyst according to the present disclosure, configuration of the oxygen evolution catalyst according to the present disclosure may vary depending on the composition of the core.

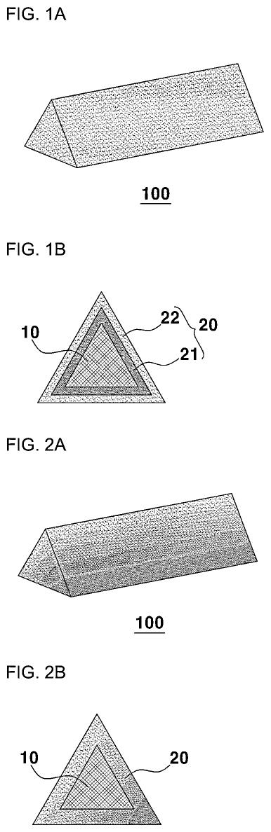

FIG. 1A shows an oxygen evolution catalyst according to a first embodiment of the present disclosure. FIG. 1B shows a cross-sectional view of the oxygen evolution catalyst according to the first embodiment.

With reference to FIGS. 1A and 1B, the oxygen evolution catalyst 100 according to the first embodiment of the present disclosure includes a core 10 including nickel sulfide and a shell 20 surrounding the surface of the core 10 and including iridium oxide and ruthenium oxide.

The core 10 may have a shape of a polyhedral prism. Specifically, the core 10 may have a shape of a triangular prism.

The core 10 may be made of a nickel sulfide precursor having a shape of a polyhedral prism having a diameter of 10 to 15 nm and a length of 60 to 70 nm, which will be described later.

In the oxygen evolution catalyst 100 according to the first embodiment of the present disclosure, the shell 20 may include a first layer 21 surrounding the core 10 and including ruthenium oxide and a second layer 22 surrounding the first layer 21 and including iridium oxide.

FIG. 2A shows an oxygen evolution catalyst according to a second embodiment of the present disclosure. FIG. 2B shows a cross-sectional view of the oxygen evolution catalyst according to the second embodiment.

With reference to FIGS. 2A and 2B, the oxygen evolution catalyst 100 according to the second embodiment of the present disclosure includes a core 10 including nickel sulfide and a shell 20 surrounding the surface of the core 10 and including iridium oxide and ruthenium oxide.

The core 10 may have a shape of a polyhedral prism. Specifically, the core 10 may have a shape of a triangular prism.

The core 10 may be made of a nickel sulfide precursor having a shape of a polyhedral prism having a diameter of 15 to 20 nm and a length of 60 to 70 nm, the surface of which is doped with iridium, which will be described later.

In the oxygen evolution catalyst 100 according to the second embodiment of the present disclosure, the shell 20 may be an alloy including an oxide of an alloy of iridium and ruthenium.

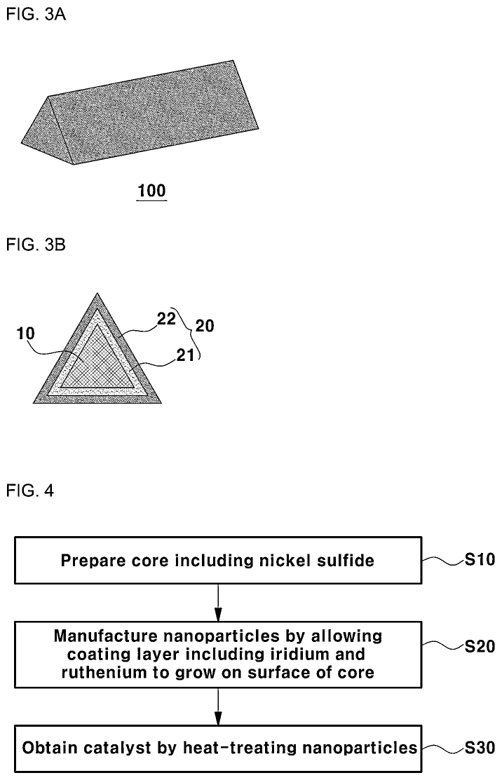

FIG. 3A shows an oxygen evolution catalyst according to a third embodiment of the present disclosure. FIG. 3B shows a cross-sectional view of the oxygen evolution catalyst according to the third embodiment.

With reference to FIGS. 3A and 3B, the oxygen evolution catalyst 100 according to the third embodiment of the present disclosure includes a core 10 including nickel sulfide and a shell 20 surrounding the surface of the core 10 and including iridium oxide and ruthenium oxide.

The core 10 may have a shape of a polyhedral prism. Specifically, the core 10 may have a shape of a triangular prism.

The core 10 may be made of a nickel sulfide precursor having a shape of a polyhedral prism having a diameter of 10 to 15 nm and a length of 60 to 70 nm, both ends of which are capped with iridium, which will be described later.

In the oxygen evolution catalyst 100 according to the third embodiment of the present disclosure, the shell 20 may include a first layer 21 surrounding the core 10 and including iridium oxide and a second layer 22 surrounding the first layer 21 and including ruthenium oxide.

Another aspect of the present disclosure pertains to a fuel cell including the oxygen evolution catalyst. The fuel cell according to the present disclosure may include a polymer electrolyte membrane, a cathode disposed on one surface of the polymer electrolyte membrane, and an anode disposed on the remaining surface of the polymer electrolyte membrane. In the fuel cell according to the present disclosure, the oxygen evolution catalyst may be applied to electrodes.

Still another aspect of the present disclosure pertains to a method of preparing an oxygen evolution catalyst. Hereinafter, the present disclosure will be described in more detail with reference to the accompanying drawings.

FIG. 4 is a flowchart showing a process of preparing the oxygen evolution catalyst according to the present disclosure.

With reference to FIG. 4, the method of preparing the oxygen evolution catalyst according to the present disclosure may include preparing a core including nickel sulfide (S10), manufacturing nanoparticles by allowing a coating layer including iridium and ruthenium to grow on the surface of the core (S20), and obtaining a catalyst by heat-treating the nanoparticles (S30). The catalyst includes the core and the shell surrounding the surface of the core and including iridium oxide and ruthenium oxide.

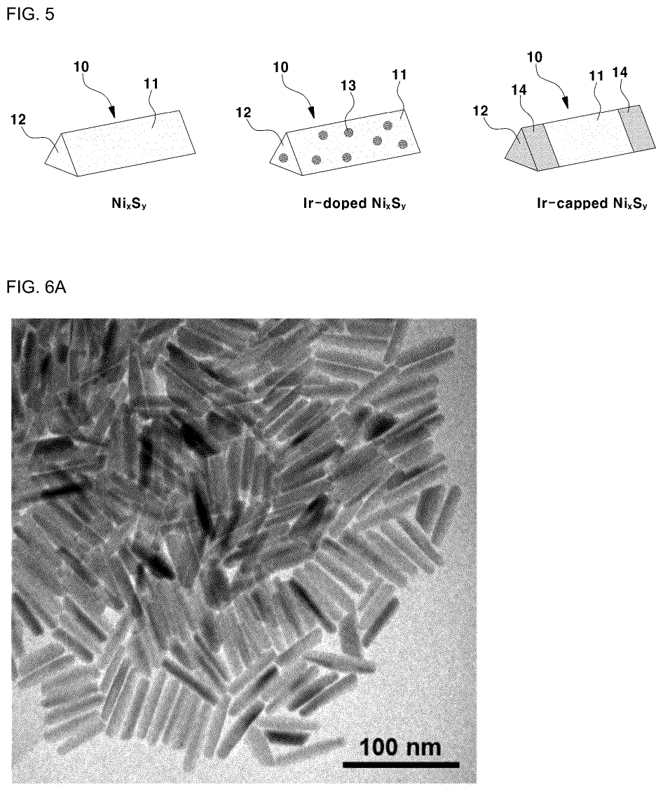

Before describing the preparation method according to the present disclosure, the method of preparing the oxygen evolution catalyst according to the present disclosure may vary depending on the composition of the core that is prepared. FIG. 5 schematically shows the shapes of the cores used in the first to third embodiments of the present disclosure.

With reference to FIGS. 4 and 5, individual steps of the method of preparing the oxygen evolution catalyst according to embodiments of the present disclosure are described in detail below.

The method of preparing the oxygen evolution catalyst according to the first embodiment of the present disclosure is described below.

In S10, preparing a first mixture by mixing a nickel precursor and a sulfide precursor, forming a first reaction material by heat-treating the first mixture in an argon atmosphere, and preparing a nickel sulfide precursor using centrifugation after addition of a solvent to the first reaction material may be performed.

Here, preparing the first mixture may be performed through a stirring process for 10 to 60 minutes under vacuum in an argon atmosphere at a temperature of 80 to 130° C.

Also, forming the first reaction material may be performed through heat treatment for 10 to 30 minutes in an argon atmosphere at a temperature of 220 to 250° C. Here, the first reaction material may be triangular prism-shaped NiₓS_{y} nanoparticles.

Also, preparing the nickel sulfide precursor may be performed through a centrifugation process at a speed of 3,000 to 5,000 rpm for 1 to 10 minutes. Here, a solvent including hexane and acetone in a ratio of 1:1 may be used for the centrifugation process.

As such, in S10, the nanoparticles are settled using centrifugation, after which the supernatant is discarded and the settled particles are dried to obtain a nickel sulfide precursor (NiₓS_{y}@Ru@Ir) in powder form. More specifically, in S10, a nickel sulfide precursor having a shape of a polyhedral prism having a diameter of 10 to 15 nm and a length of 60 to 70 nm is finally prepared.

The nickel sulfide precursor prepared in S10 is used for the core in the present disclosure.

As shown in (a) of FIG. 5, the core 10 according to the first embodiment may have first crystal planes 11 corresponding to the outer surfaces of the prism and second crystal planes 12 corresponding to the top and bottom surfaces of the prism.

Then, in S20, mixing the nickel sulfide precursor, an iridium precursor, and a ruthenium precursor, allowing iridium and ruthenium to grow on the surface of the nickel sulfide precursor by heat-treating the mixture in an argon atmosphere, and manufacturing nanoparticles in powder form using centrifugation after addition of a solvent to the result after growth of iridium and ruthenium may be performed.

Here, the mixing may be performed for 10 to 60 minutes under vacuum in an argon atmosphere at a temperature of 70 to 90° C.

Also, allowing iridium and ruthenium to grow may be performed through heat treatment for 3 to 5 hours in an argon atmosphere at a temperature of 220 to 250° C.

Also, preparing the nickel sulfide precursor may be performed through a centrifugation process at a speed of 3,000 to 5,000 rpm for 1 to 10 minutes. Here, a solvent including hexane and acetone in a ratio of 1:1 may be used for the centrifugation process.

Finally, in S30, a catalyst is obtained by heat-treating the nanoparticles.

In S30, a heat treatment process may be performed for 30 minutes to 120 minutes under oxygen conditions at a temperature of 350 to 450° C.

Ultimately, in S30, the oxygen evolution catalyst according to the first embodiment configured such that the shell includes a first layer surrounding the core and including ruthenium oxide and a second layer surrounding the first layer and including iridium oxide is prepared.

In addition, the method of preparing the oxygen evolution catalyst according to the second embodiment of the present disclosure is described below.

In S10, preparing a first mixture by mixing a nickel precursor and a sulfide precursor, forming a first reaction material by heat-treating the first mixture in an argon atmosphere, preparing a second mixture by injecting an iridium precursor to the first reaction material, forming a second reaction material by heat-treating the second mixture in an argon atmosphere, and preparing a nickel sulfide precursor using centrifugation after addition of a solvent to the second reaction material may be performed.

Here, preparing the first mixture may be performed through a stirring process for 10 to 60 minutes under vacuum in an argon atmosphere at a temperature of 80 to 130° C.

Also, forming the first reaction material may be performed through heat treatment for 10 to 30 minutes in an argon atmosphere at a temperature of 220 to 250° C.

Also, preparing the second mixture may be performed through a dispersion process using a sonication (ultrasound) method.

Also, forming the second reaction material may be performed through heat treatment for 2 to 5 hours in an argon atmosphere at a temperature of 220 to 250° C. Here, the second reaction material may be NiₓS_{y} nanoparticles having a triangular prism shape and a surface doped with Ir.

Also, preparing the nickel sulfide precursor may be performed through a centrifugation process at a speed of 3,000 to 5,000 rpm for 1 to 10 minutes. Here, a solvent including hexane and acetone in a ratio of 1:1 may be used for the centrifugation process. In S10, the nanoparticles are settled using centrifugation, after which the supernatant is discarded and the settled particles are dried to obtain a nickel sulfide precursor (Ir-doped NiₓS_{y}@Ru@Ir) in powder form. More specifically, in S10, a nickel sulfide precursor having a shape of a polyhedral prism having a diameter of 15 to 20 nm and a length of 60 to 70 nm, the surface of which is doped with iridium, is finally prepared.

The nickel sulfide precursor prepared in S10 is used for the core in the present disclosure.

As shown in (b) of FIG. 5, the core 10 according to the second embodiment may have first crystal planes 11 corresponding to the outer surfaces of the prism and second crystal planes 12 corresponding to the top and bottom surfaces of the prism.

Also, iridium may be provided as a doping material 13 in the surfaces of the first crystal planes 11 and the second crystal planes 12 of the core 10 according to the second embodiment.

Then, in S20, mixing the nickel sulfide precursor, an iridium precursor, and a ruthenium precursor, allowing iridium and ruthenium to grow on the surface of the nickel sulfide precursor by heat-treating the mixture in an argon atmosphere, and manufacturing nanoparticles in powder form using centrifugation after addition of a solvent to the result after growth of iridium and ruthenium may be performed.

Here, the mixing may be performed for 10 to 60 minutes in an argon atmosphere at a temperature of 70 to 90° C.

Also, allowing iridium and ruthenium to grow may be performed through heat treatment for 3 to 5 hours in an argon atmosphere at a temperature of 220 to 250° C.

Also, preparing the nickel sulfide precursor may be performed through a centrifugation process at a speed of 3,000 to 5,000 rpm for 1 to 10 minutes. Here, a solvent including hexane and acetone in a ratio of 1:1 may be used for the centrifugation process.

Finally, in S30, a catalyst is obtained by heat-treating the nanoparticles.

In S30, a heat treatment process may be performed for 30 minutes to 120 minutes under oxygen conditions at a temperature of 350 to 450° C.

Ultimately, in S30, the oxygen evolution catalyst according to the second embodiment configured such that the shell surrounds the core and the shell is an alloy including an oxide of an alloy of iridium and ruthenium is prepared.

In addition, the method of preparing the oxygen evolution catalyst according to the third embodiment of the present disclosure is described below.

In S10, preparing a first mixture by mixing a nickel precursor and a sulfide precursor, forming a first reaction material by heat-treating the first mixture in an argon atmosphere, preparing an intermediate using centrifugation after addition of a solvent to the first reaction material, preparing a third mixture by injecting an iridium precursor to the intermediate, forming a third reaction material by heat-treating the third mixture in an argon atmosphere, and preparing a nickel sulfide precursor using centrifugation after addition of a solvent to the third reaction material may be performed.

Here, preparing the first mixture may be performed through a stirring process for 10 to 60 minutes under vacuum in an argon atmosphere at a temperature of 80 to 130° C.

Also, forming the first reaction material may be performed through heat treatment for 10 to 30 minutes in an argon atmosphere at a temperature of 220 to 250° C.

Also, preparing the intermediate may be performed through a centrifugation process at a speed of 3,000 to 5,000 rpm for 1 to 10 minutes. Here, a solvent including hexane and acetone in a ratio of 1:1 may be used for the centrifugation process.

Also, preparing the third mixture may be performed through a stirring process in an argon atmosphere at a temperature of 70 to 90° C.

Also, preparing the third reaction material may be performed through heat treatment for 30 to 90 minutes in an argon atmosphere at a temperature of 220 to 250° C. Here, the third reaction material may be NiₓS_{y} nanoparticles having a triangular prism shape, both ends of which are capped with Ir.

Also, preparing the nickel sulfide precursor may be performed through a centrifugation process at a speed of 3,000 to 5,000 rpm for 1 to 10 minutes. Here, a solvent including hexane and acetone in a ratio of 1:1 may be used for the centrifugation process.

Here, in S10, the nanoparticles are settled using centrifugation, after which the supernatant is discarded and the settled particles are dried to obtain a nickel sulfide precursor (Ir-capped NiₓS_{y}@Ru@Ir) in powder form. More specifically, in S10, a nickel sulfide precursor having a shape of a polyhedral prism having a diameter of 10 to 15 nm and a length of 60 to 70 nm, both ends of which are capped with Ir, is finally prepared.

The nickel sulfide precursor prepared in S10 is used for the core in the present disclosure.

As shown in (c) of FIG. 5, the core 10 according to the third embodiment may have first crystal planes 11 corresponding to the outer surfaces of the prism and second crystal planes 12 corresponding to the top and bottom surfaces of the prism.

Also, the core 10 according to the third embodiment may have a structure in which both ends are capped with iridium as a capping material 14.

Then, in S20, mixing the nickel sulfide precursor and a ruthenium precursor, allowing iridium and ruthenium to grow on the surface of the nickel sulfide precursor by heat-treating the mixture in an argon atmosphere, and manufacturing nanoparticles in powder form using centrifugation after addition of a solvent to the result after growth of iridium and ruthenium may be performed.

Here, the mixing may be performed for 10 to 60 minutes in an argon atmosphere at a temperature of 70 to 90° C.

Also, allowing iridium and ruthenium to grow may be performed through heat treatment for 3 to 5 hours in an argon atmosphere at a temperature of 220 to 250° C.

Also, preparing the nickel sulfide precursor may be performed through a centrifugation process at a speed of 3,000 to 5,000 rpm for 1 to 10 minutes. Here, a solvent including hexane and acetone in a ratio of 1:1 may be used for the centrifugation process.

Finally, in S30, a catalyst is obtained by heat-treating the nanoparticles.

In S30, a heat treatment process may be performed for 30 minutes to 120 minutes under oxygen conditions at a temperature of 350 to 450° C.

Ultimately, in S30, the oxygen evolution catalyst according to the third embodiment configured such that the shell includes a first layer surrounding the core and including iridium oxide and a second layer surrounding the first layer and including ruthenium oxide is prepared.

A better understanding of the present disclosure may be obtained through the following examples. These examples are merely set forth to illustrate the present disclosure, and are not to be construed as limiting the scope of the present disclosure.

Before examples of the present disclosure, “@” is a symbol for indicating a core-shell structure, and may generally be represented in the form of “core@shell”.

### Example 1

A NiₓS_{y} precursor in which iridium was not pre-introduced and a NiₓS_{y}@Ru@Ir anode catalyst using the same were prepared. The specific preparation method was as follows.

0.0778 g (0.6 mmol) of nickel(II) chloride and 0.3150 g (1.219 mmol) of 1,2-hexadecanediol were placed in a 100 mL reaction vessel, and 0.6 mL of oleic acid, 3.6 mL of oleylamine, and 15 mL of 1-octadecene were further placed in the reaction vessel. Subsequently, the mixture in the reaction vessel was dissolved with stirring under vacuum at 90° C. for 10 minutes, and then argon gas was injected to create an argon environment. Thereafter, 1.5 mL of 1-dodecanethiol, which serves to provide sulfur for NiₓS_{y} synthesis, was quickly injected into the reaction vessel, followed by stirring for 40 minutes in an argon environment at 120° C. and then reaction in an argon environment at 225° C. for 15 minutes, thus obtaining triangular prism-shaped NiₓS_{y} nanoparticles.

Subsequently, hexane and acetone were added in a 1:1 ratio to the reaction product in which the synthesized NiₓS_{y} was dispersed, after which the NiₓS_{y} particles were settled using centrifugation (at 4,000 rpm for 5 minutes). After completion of centrifugation, the supernatant was discarded and the settled particles were dried to obtain a NiₓS_{y} precursor in powder form.

25 mg of the synthesized NiₓS_{y} precursor, 0.1542 g (0.315 mmol) of iridium(III) acetylacetonate, and 0.2510 g (0.630 mmol) of ruthenium(III) acetylacetonate were weighed and placed in a 100 mL reaction vessel along with 25 mL of oleylamine. Subsequently, the mixture in the reaction vessel was dissolved with stirring under vacuum at 80° C., and then argon was injected to create an argon environment. Subsequently, reaction was carried out at 240° C. for 4 hours, thereby obtaining nanoparticles having a structure (NiₓS_{y}@Ru@Ir) in which ruthenium and iridium sequentially grew on the precursor.

Subsequently, toluene and methanol were added in a 1:1 ratio to the reaction product in which the synthesized NiₓS_{y}@Ru@Ir was dispersed, and then the nanoparticles were settled using centrifugation. After completion of centrifugation, the supernatant was discarded and the settled particles were dried to obtain NiₓS_{y}@Ru@Ir in powder form.

Finally, the iridium ruthenium-based catalyst (NiₓS_{y}@Ru@Ir) prepared as described above was subjected to thermal oxidation for 1 hour at a high temperature (400° C.) under oxygen conditions. Through this process, the iridium ruthenium-based metals present in the shell may be converted into oxide species. Ultimately, a NiₓS_{y}@Ru@Ir anode catalyst having an iridium ruthenium protrusion structure was prepared.

### Example 2

An Ir-doped NiₓS_{y} precursor in which iridium was pre-introduced in a doped form and a NiₓS_{y}@RuIr anode catalyst using the same were prepared. The specific preparation method was as follows.

Up to the procedures of reaction for 15 minutes in an argon environment at 225° C. were the same as the NiₓS_{y} precursor synthesis process in which iridium was not pre-introduced in Example 1.

In Example 2, for synthesis of the Ir-doped NiₓS_{y} nanoparticle precursor, one step was added in the NiₓS_{y} precursor synthesis process.

Specifically, 0.0367 g (0.075 mmol) of iridium(III) acetylacetonate and 9 mL of oleylamine were placed in a separate reaction vessel, and then dispersed into a solution through a sonication (ultrasound) method to afford an iridium solution.

After completion of reaction at 225° C. for 15 minutes in the reaction vessel during synthesis in the NiₓS_{y} precursor synthesis process, the dispersed iridium solution was rapidly injected into the reaction vessel. Thereafter, reaction was carried out at 240° C. for 3 hours, thereby obtaining Ir-doped NiₓS_{y} nanoparticles in which the surface of the triangular prism was doped with iridium.

In the same manner as in the synthesis method of Example 1, hexane and acetone were added in a 1:1 ratio to the reaction product in which the synthesized Ir-doped NiₓS_{y} was dispersed, and then the synthesized nanoparticles were settled using centrifugation (at 4,000 rpm for 5 minutes). After completion of centrifugation, the supernatant was discarded and the settled particles were dried to obtain an Ir-doped NiₓS_{y} precursor in powder form.

25 mg of the synthesized Ir-doped NiₓS_{y} precursor, 0.1419 g (0.290 mmol) of iridium(III) acetylacetonate in consideration of the amount of iridium in the precursor, and 0.2510 g (0.630 mmol) of ruthenium(III) acetylacetonate were weighed and placed in a 100 mL reaction vessel along with 25 mL of oleylamine. Subsequently, the mixture in the reaction vessel was dissolved with stirring under vacuum at 80° C., and then argon was injected to create an argon environment. Then, reaction was carried out at 240° C. for 4 hours, thereby obtaining NiₓS_{y}@Ru—Ir nanoparticles in which iridium and ruthenium grew in the form of an alloy on the Ir-doped precursor.

Finally, the iridium ruthenium-based catalyst (NiₓS_{y}@Ru—Ir) prepared as described above was subjected to thermal oxidation for 1 hour at a high temperature (400° C.) under oxygen conditions. Through this process, the iridium ruthenium-based metals present in the shell may be converted into oxide species. Ultimately, a NiₓS_{y}@Ru—Ir anode catalyst having an iridium ruthenium protrusion structure present in the shell was prepared.

### Example 3

An Ir-capped NiₓS_{y} precursor in which iridium was pre-introduced in a capped form and a NiₓS_{y}@Ir@Ru anode catalyst using the same were prepared. The specific preparation method was as follows.

0.0441 g (0.09 mmol) of iridium(III) acetylacetonate was added to 10 mg of the NiₓS_{y} precursor synthesized in Example 1 in a 50 mL reaction vessel along with 10 ml of oleylamine, and then dissolved with stirring under vacuum at 80° C., after which argon was injected to create an argon environment. Then, reaction was carried out at 240° C. for 1 hour, thereby obtaining Ir-capped NiₓS_{y} nanoparticles in which the top and bottom surfaces of the NiₓS_{y} triangular prism were capped with Ir.

Subsequently, hexane and acetone were added in a 1:1 ratio to the Ir-capped NiₓS_{y} nanoparticles, and then the synthesized nanoparticles were settled using centrifugation (at 4,000 rpm for 5 minutes). After completion of centrifugation, the supernatant was discarded and the settled particles were dried to obtain an Ir-capped NiₓS_{y} precursor in powder form.

25 mg of the synthesized Ir-capped NiₓS_{y} precursor and 0.0717 g (0.180 mmol) of ruthenium(III) acetylacetonate were placed in a 100 mL reaction vessel along with 15 mL of oleylamine, and then dissolved with stirring under vacuum at 80° C., after which argon was injected to create an argon environment. Then, reaction was carried out at 240° C. for 3 hours, thus obtaining nanoparticles having a structure (NiₓS_{y}@Ir@Ru) in which iridium and ruthenium sequentially grew on the precursor.

Toluene and methanol were added in a 1:1 ratio to the synthesized NiₓS_{y}@Ir@Ru, after which the nanoparticles were settled using centrifugation. Then, the supernatant was discarded and the settled particles were dried to obtain NiₓS_{y}@Ir@Ru in powder form.

Finally, the iridium ruthenium-based catalyst (NiₓS_{y}@Ir@Ru) prepared as described above was subjected to thermal oxidation for 1 hour at a high temperature (400° C.) under oxygen conditions. Through this process, the iridium ruthenium-based metals present in the shell may be converted into oxide species. Ultimately, a NiₓS_{y}@Ir@Ru anode catalyst present in the shell was prepared.

### Test Example 1 (Analysis of Structure and Component of Precursor)

The physical properties of the NiₓS_{y}-based precursors prepared as described above were analyzed using transmission electron microscopy (TEM) and X-ray diffraction.

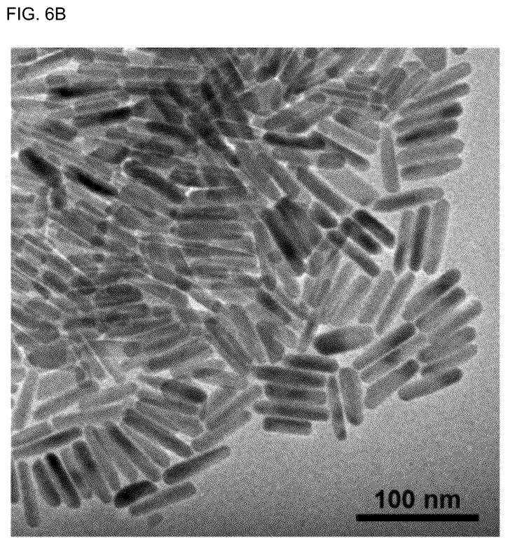

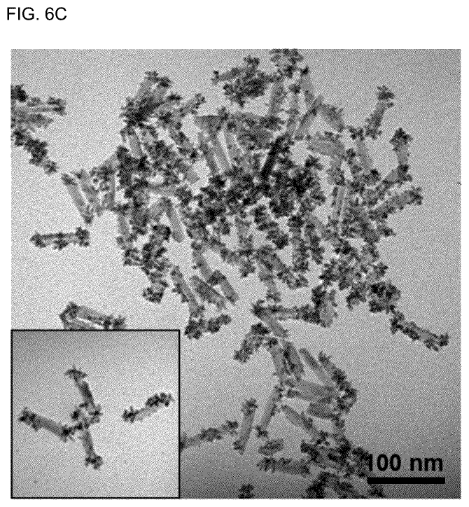

FIG. 6A shows a TEM image of the NiₓS_{y} precursor according to Example 1, FIG. 6B shows a TEM image of the Ir-doped NiₓS_{y} precursor according to Example 2, and FIG. 6C shows a TEM image of the Ir-capped NiₓS_{y} precursor according to Example 3.

With reference to FIGS. 6A and 6B, it can be seen that prism-shaped NiₓS_{y} nanoparticles having a length of about 60 to 70 nm were synthesized. Also, when the NiₓS_{y}-based precursor was doped with iridium, the thickness thereof was increased by about 10 nm compared to the undoped precursor.

Also, with reference to FIG. 6C, it was confirmed that Ir particles regiospecifically grew on the top and bottom surfaces of the prism-shaped NiₓS_{y} precursor.

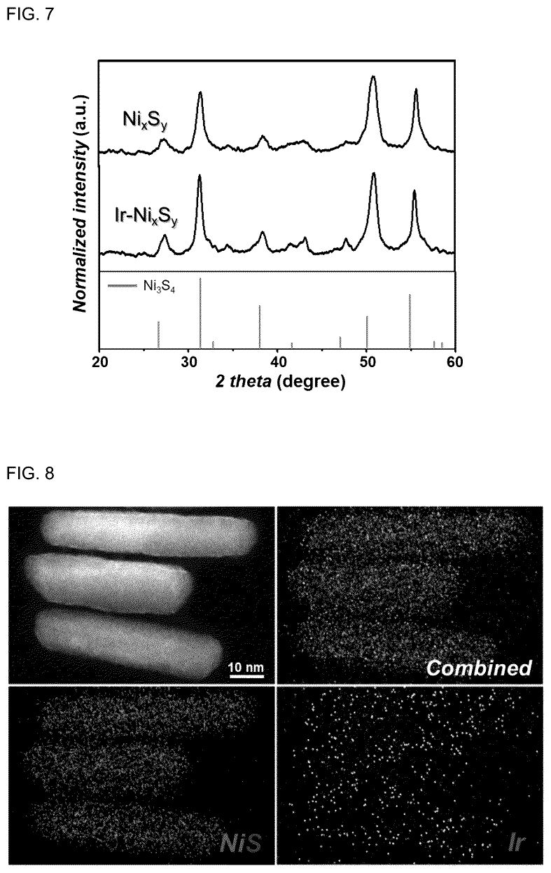

FIG. 7 shows results of X-ray diffraction of the NiₓS_{y} precursor according to Example 1 and the Ir-doped NiₓS_{y} according to Example 2.

With reference to FIG. 7, the two precursors matched the Ni₃S₄ phase and there was a slight peak shift depending on the presence or absence of doped iridium.

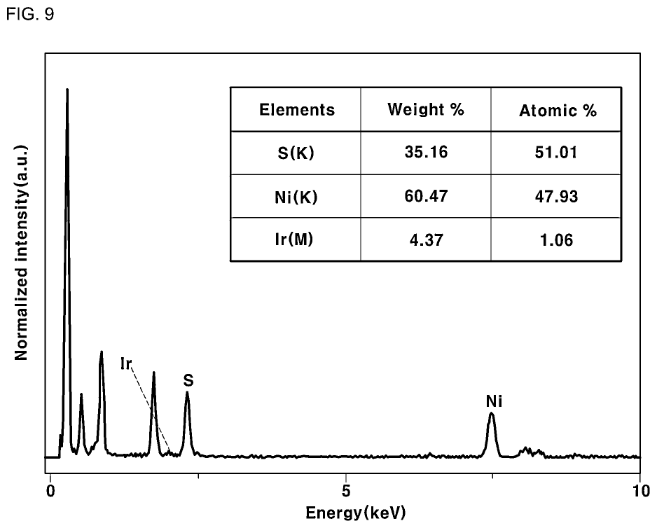

FIG. 8 shows results of energy dispersive X-ray spectroscopy (EDX) of Ir-doped NiₓS_{y} according to Example 2. FIG. 9 shows an EDX mapping image of Ir-doped NiₓS_{y} according to Example 2.

With reference to FIGS. 8 and 9, it was confirmed that the surface of the prism-shaped nanoparticles was doped with about 1% of iridium.

### Test Example 2 (Analysis of Structure and Component of Catalyst Before Oxidation)

An iridium ruthenium-based catalyst was prepared by allowing iridium ruthenium metals to grow on the NiₓS_{y}-based precursor prepared as described above, and then the physical properties thereof were analyzed using transmission electron microscopy (TEM) and X-ray diffraction.

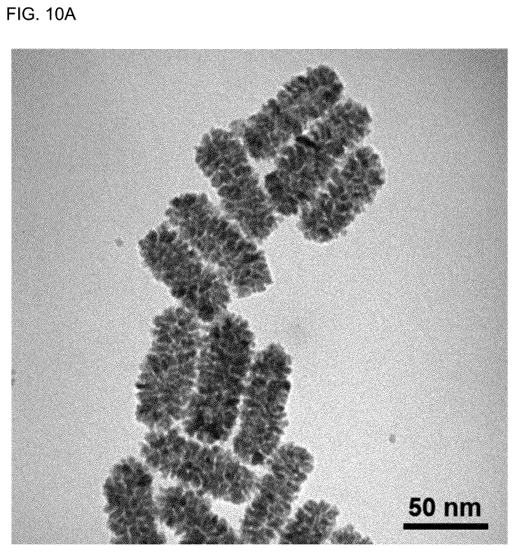

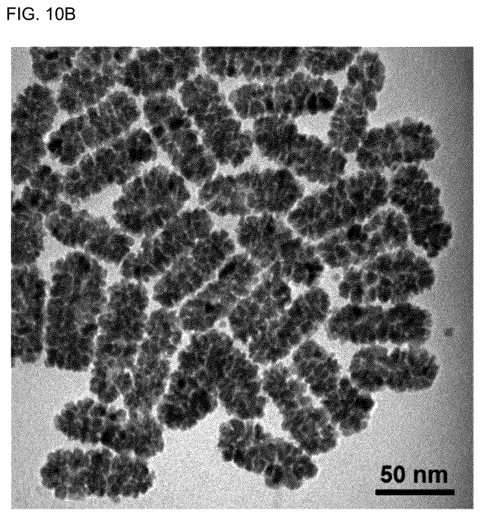

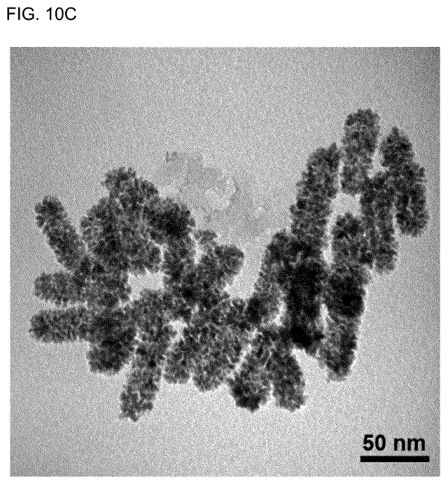

FIG. 10A shows a TEM image of the NiₓS_{y}@Ru@Ir catalyst according to Example 1, FIG. 10B shows a TEM image of the NiₓS_{y}@RuIr catalyst according to Example 2, and FIG. 10c shows a TEM image of the NiₓS_{y}@Ir@Ru catalyst according to Example 3.

With reference to FIGS. 10A, 10B, and 10C, the catalysts prepared in Examples were all confirmed to have a nanocactus shape in which small protrusions grew on the precursor prism. Therefore, it is determined that the shape of the prepared catalyst is not affected by the presence or absence of pre-introduced iridium in the NiₓS_{y} precursor.

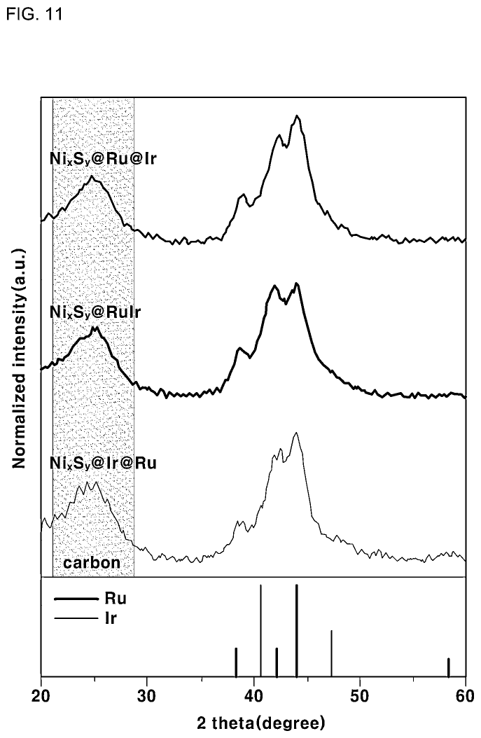

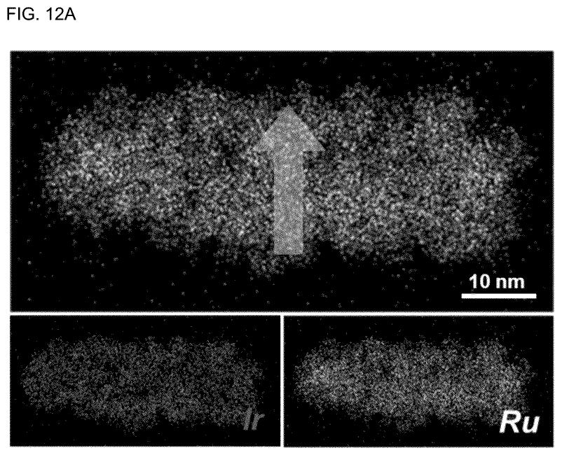

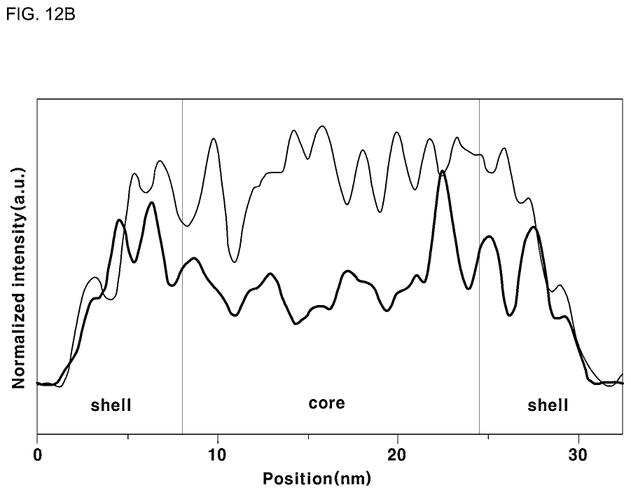

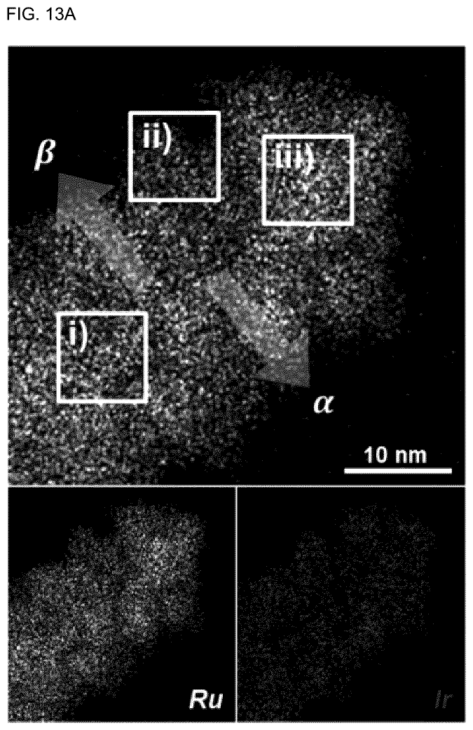

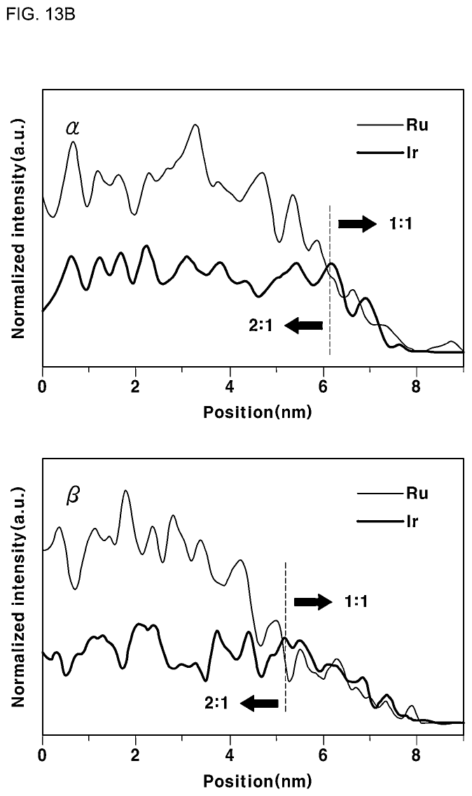

FIG. 11 shows results of X-ray diffraction of the catalysts according to Examples 1 to 3.

With reference to FIG. 11, in the three synthesized nanocatalysts, peaks for ruthenium having an hcp structure were predominantly observed (yellow), and there was no significant difference in crystals.

FIGS. 12A and 12B show results of EDX of the catalyst according to Example 1.

With reference to FIGS. 12A and 12B, when iridium and ruthenium were allowed to grow on the Ni₃S₄ precursor to which iridium was not introduced, a composition distribution of NiₓS_{y} core-ruthenium inner shell-iridium outer shell (NiₓS_{y}@Ru@Ir) in which ruthenium first grew evenly on the entire precursor and then iridium grew on the outer portions of the particles was shown.

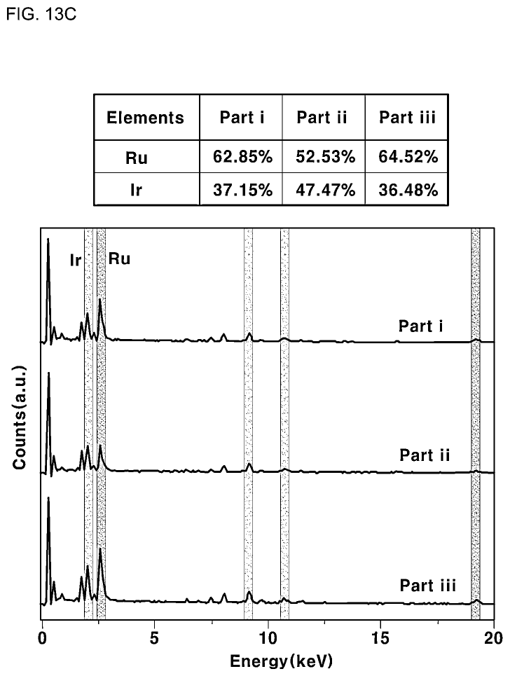

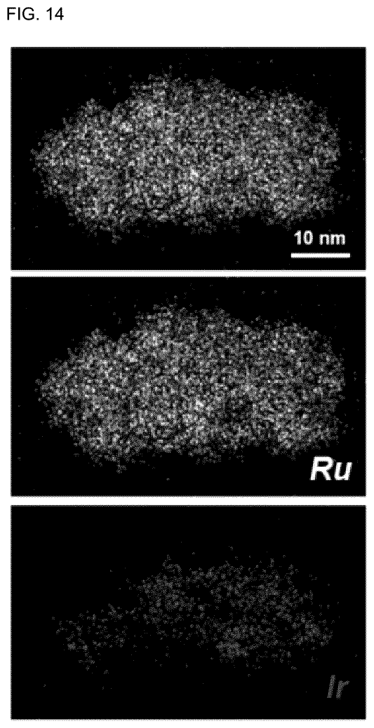

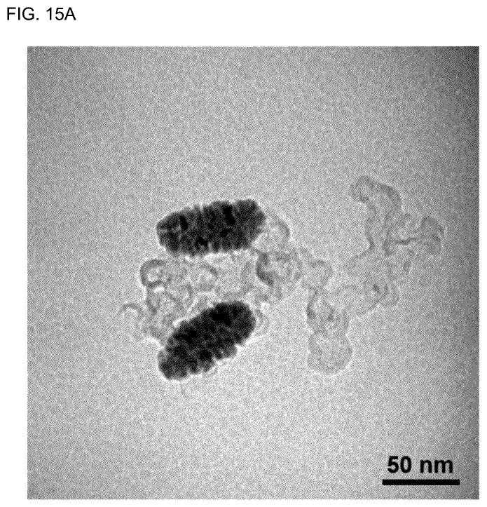

FIGS. 13A and 13B show results of EDX of the catalyst according to Example 2, and FIG. 13C shows an EDX mapping image of the catalyst according to Example 2.

With reference to FIGS. 13A, 13B, and 13C, the catalyst prepared by allowing iridium and ruthenium to grow on the iridium-doped precursor showed that iridium and ruthenium were evenly distributed over the entire portions of the nanoparticles through EDX mapping analysis. Thereby, it was found that the catalyst according to Example 2 had a structure having a composition distribution of NiₓS_{y} core-RuIr alloy shell (NiₓS_{y}@RuIr). Also, the catalyst according to Example 2 was configured such that ruthenium and iridium were maintained at a ratio of 2:1 inside the particles, but tended to be alloyed at a ratio of 1:1 toward the outside of the particles.

FIG. 14 shows results of EDX of the catalyst according to Example 3.

With reference to FIG. 14, the catalyst prepared by allowing iridium and ruthenium to grow on the iridium-capped precursor had a composition distribution of NiₓS_{y} core-iridium inner shell-ruthenium outer shell (NiₓS_{y}@Ir@Ru) in which iridium first grew on the surface of the precursor due to the influence of excess iridium present in the precursor and ruthenium grew on the outermost surface.

Therefore, according to the present disclosure, it was confirmed that the initial growth tendency and miscibility of iridium and ruthenium growing on the precursor varied depending on whether or not iridium is pre-introduced into the precursor.

Also, according to the present disclosure, it was possible to prepare three types of anode catalysts (NiₓS_{y}@Ru@Ir, NiₓS_{y}@RuIr, and NiₓS_{y}@Ir@Ru) in which the composition distribution in the nanoparticles was controlled.

### Test Example 3 (Analysis of Structure and Component of Anode Catalyst Subjected to Oxidation at High Temperature)

An anode catalyst was prepared by subjecting the iridium ruthenium-based catalyst prepared as described above to thermal oxidation at a high temperature of 400° C. under oxygen conditions, and the physical properties thereof were analyzed using transmission electron microscopy (TEM) and X-ray diffraction. Here, in order to prevent aggregation of the nanoparticles during thermal oxidation at a high temperature, the nanoparticles were supported on a carbon support (Vulcan carbon, XC-72R) and then subjected to a thermal oxidation process.

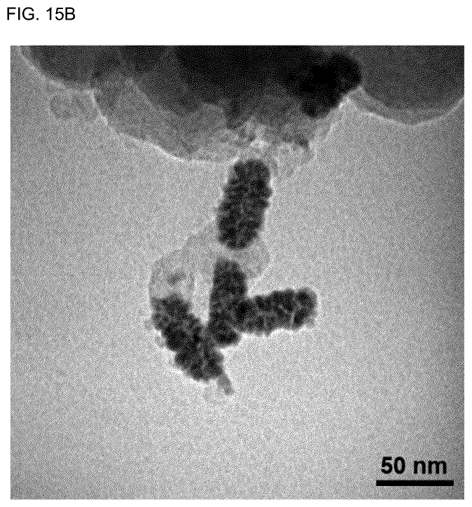

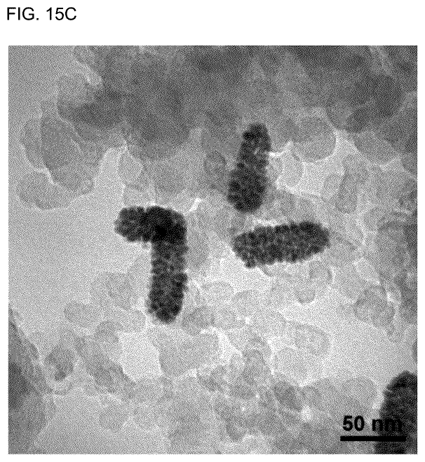

FIG. 15A shows a TEM image of the NiₓS_{y}@Ru@Ir-A catalyst subjected to thermal oxidation according to Example 1, FIG. 15B shows a TEM image of the NiₓS_{y}@Ru—Ir-A catalyst subjected to thermal oxidation according to Example 2, and FIG. 15C shows a TEM image of the NiₓS_{y}@Ir@Ru-A anode catalyst subjected to thermal oxidation according to Example 3.

With reference to FIGS. 15A, 15B, and 15C, it was confirmed that the nanocactus shape before thermal oxidation was maintained because a protrusion structure was present in all three catalysts subjected to thermal oxidation.

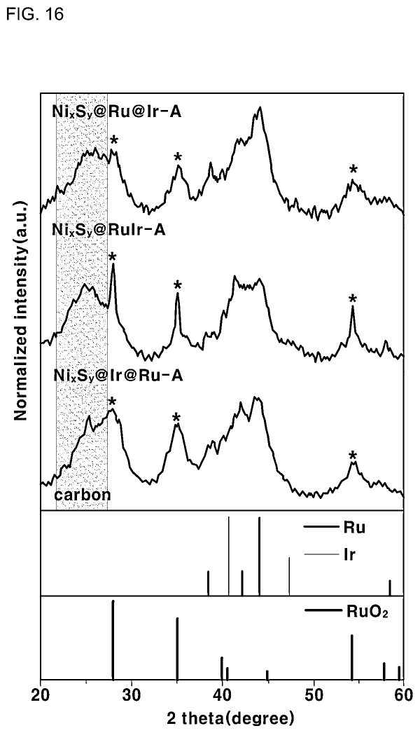

FIG. 16 shows results of X-ray diffraction of the catalysts subjected to thermal oxidation at a high temperature according to Examples.

With reference to FIG. 16, ruthenium oxide (RuO₂) was formed after thermal oxidation in all three catalysts subjected to thermal oxidation.

In the NiₓS_{y}@Ru—Ir-A catalyst subjected to thermal oxidation according to Example 2, the proportion of ruthenium oxide formed was high compared to the NiₓS_{y}@Ru@Ir-A subjected to thermal oxidation according to Example 1 and the NiₓS_{y}@Ir@Ru-A catalyst subjected to thermal oxidation according to Example 3.

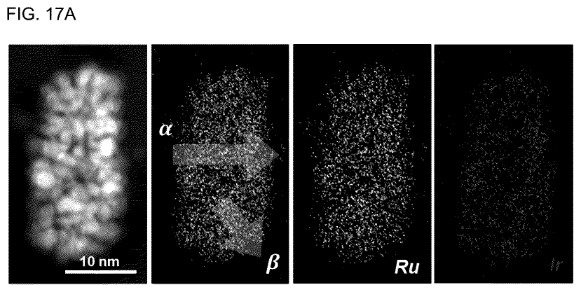

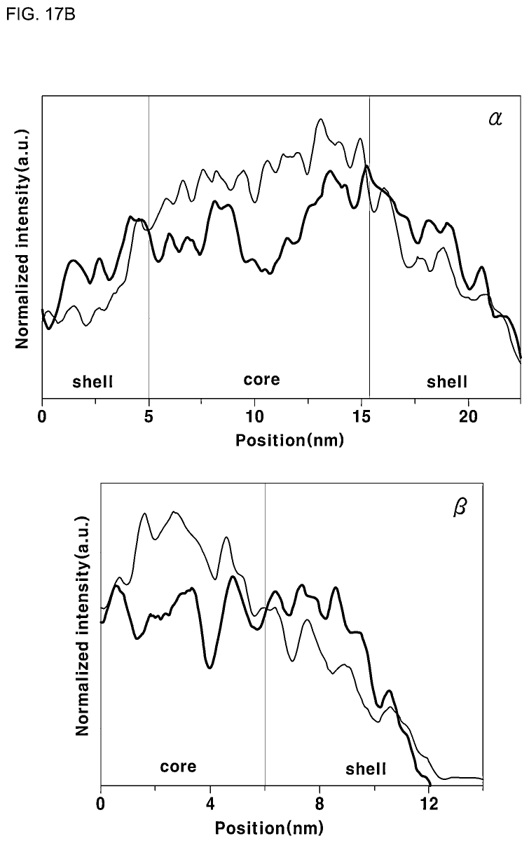

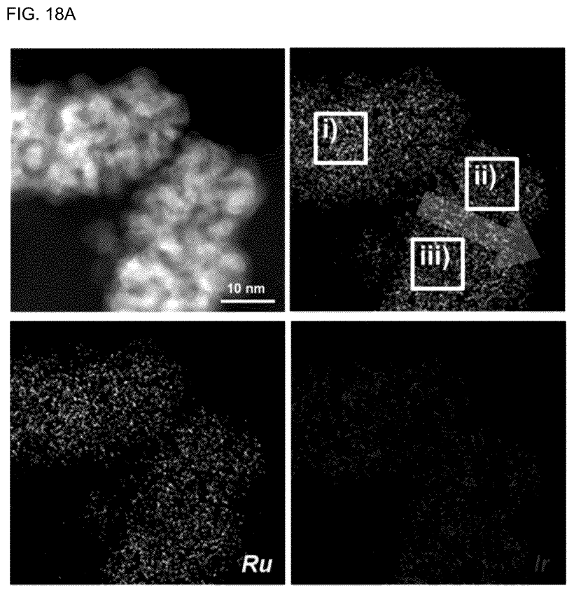

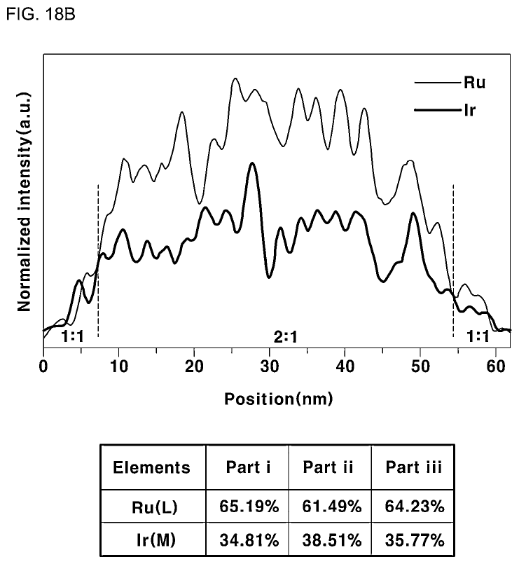

FIGS. 17A and 17B show results of EDX of the catalyst subjected to thermal oxidation according to Example 1.

With reference to FIGS. 17A and 17B, in the NiₓS_{y}@Ru@Ir-A catalyst subjected to thermal oxidation, ruthenium, which had grown uniformly throughout the precursor surface, became ruthenium oxide species through thermal oxidation and tended to move to the central core of the particles. This is judged to further maximize the segregation of the ruthenium inner shell-iridium outer shell.

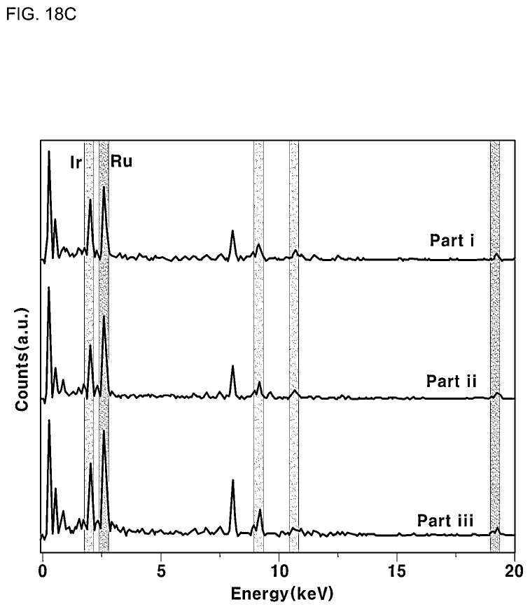

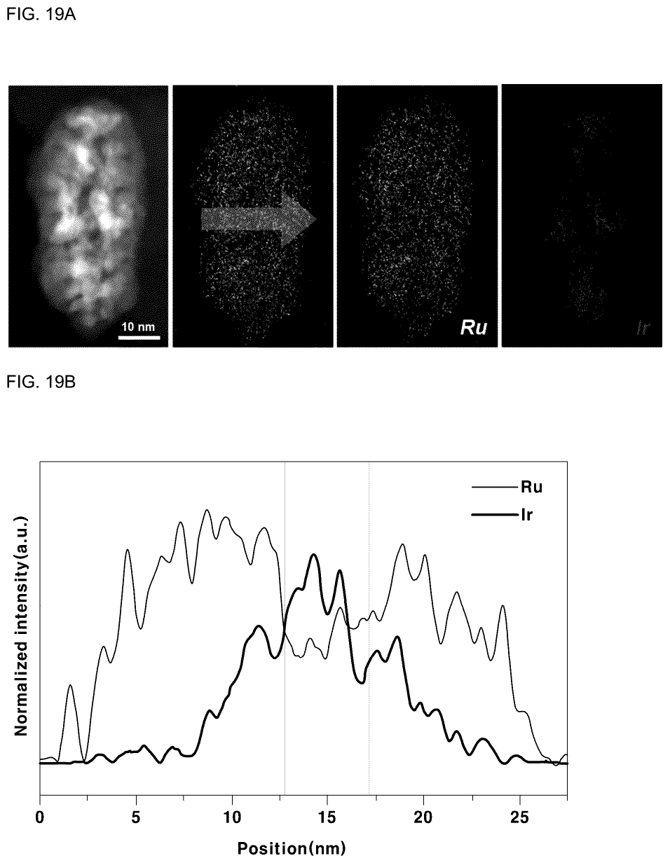

FIGS. 18A and 18C show results of EDX of the catalyst subjected to thermal oxidation according to Example 2, and FIG. 18B shows an EDX mapping image of the catalyst subjected to thermal oxidation according to Example 2.

With reference to FIGS. 18A, 18B, and 18C, the NiₓS_{y}@Ru—Ir-A catalyst subjected to thermal oxidation maintained the tendency of alloying of ruthenium and iridium before and after thermal oxidation, and the alloying ratio between the two metals was different inside and outside the particles, as in the NiₓS_{y}@Ru—Ir catalyst before thermal oxidation.

FIGS. 19A and 19B show results of EDX of the catalyst subjected to thermal oxidation according to Example 3.

With reference to FIGS. 19A and 19B, the NiₓS_{y}@Ir@Ru-A catalyst subjected to thermal oxidation also had the same distribution tendency of the iridium inner shell-ruthenium outer shell before and after thermal oxidation.

Therefore, the oxide formation tendency after thermal oxidation and changes in composition distribution thereof were confirmed in all catalysts prepared according to the present disclosure. Specifically, in the present disclosure, when thermal oxidation was performed at a high temperature of 400° C. under oxygen conditions, the type and distribution tendency of oxides formed after thermal oxidation also varied depending on the initial growth tendency and miscibility of iridium and ruthenium grown on the precursor.

### Test Example 4 (Chemical Bonding State and Oxidation State)

The chemical bonding state and oxidation state of the nanoparticles were confirmed using X-ray photoelectron spectroscopy (XPS) for the anode catalysts subjected to thermal oxidation according to Examples.

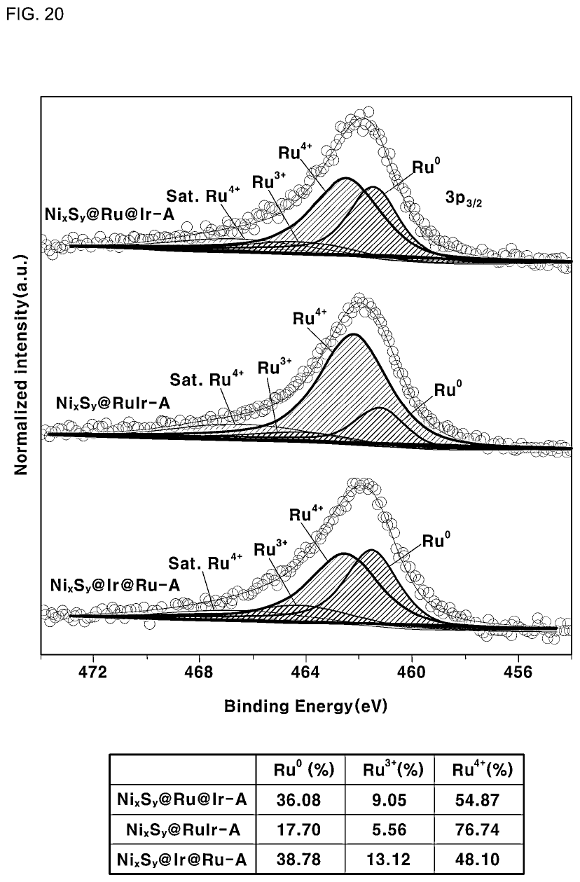

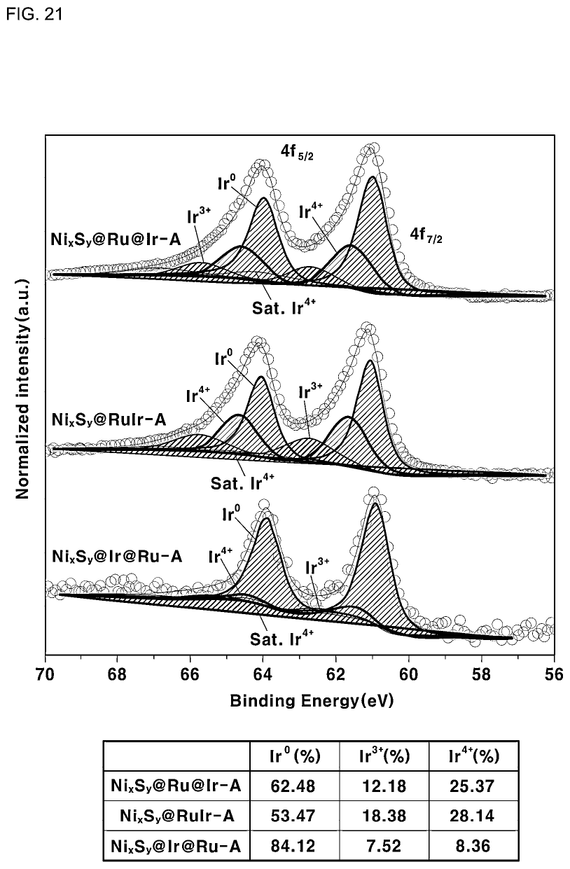

FIG. 20 shows results of XPS of Ru in the catalysts subjected to thermal oxidation according to Examples, and FIG. 21 shows results of XPS of Ir in the catalysts subjected to thermal oxidation according to Examples.

With reference to FIGS. 20 and 21, the three catalysts showed zerovalent, trivalent, and tetravalent core level peaks in the Ru 3p and Ir 4f regions.

Therefore, after thermal oxidation, both the NiₓS_{y}@Ru@Ir according to Example 1 and the NiₓS_{y}@Ir@Ru catalyst according to Example 3 showed a zerovalent Ru 3p peak conspicuously.

However, in the NiₓS_{y}@Ru—Ir catalyst according to Example 2, the intensity of the zerovalent Ru 3p peak was decreased and the tetravalent Ru peak was greatly increased.

Also, in the Ir 4f region, the zerovalent Ir 4f peak was large in all three catalysts, and the NiₓS_{y}@RuIr catalyst according to Example 2 showed a trivalent Ir peak having relatively high intensity. This is deemed to be because the ruthenium-based oxide was effectively formed after thermal oxidation, and also because the oxide formation tendency of iridium was relatively less than that of ruthenium. Moreover, the NiₓS_{y}@Ru—Ir catalyst according to Example 2, in which the RuIr shell grew in an alloy form on the precursor, had a structure with a high proportion of amorphous iridium trivalent species with high OER catalytic activity after thermal oxidation, and also many rutile ruthenium tetravalent species that increase durability.

### Test Example 5 (OER Active Half-Cell Evaluation)

In order to confirm the oxygen evolution reaction (OER) activity and stability of the anode catalysts subjected to thermal oxidation according to Examples, electrochemical characteristics were evaluated in a half cell.

Specifically, evaluation of electrochemical characteristics in the half cell was performed by constructing a half-cell system having three electrodes.

The three electrodes were a glassy carbon electrode (GCE) as a working electrode, a saturated Ag/AgCl electrode as a reference electrode, and a graphite rod as a counter electrode.

Also, evaluation was performed using a rotating disc electrode using catalyst-coated GCE. A CH Instruments electrochemical potentiostat (CHI potentiostat) was used for all electrochemical evaluations.

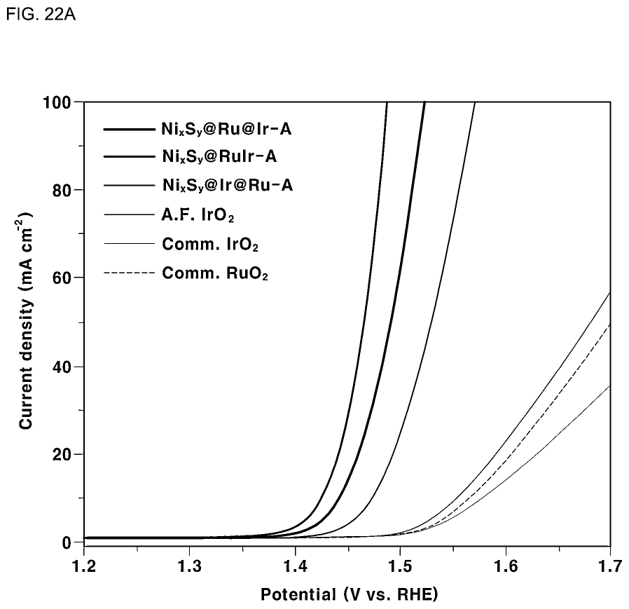

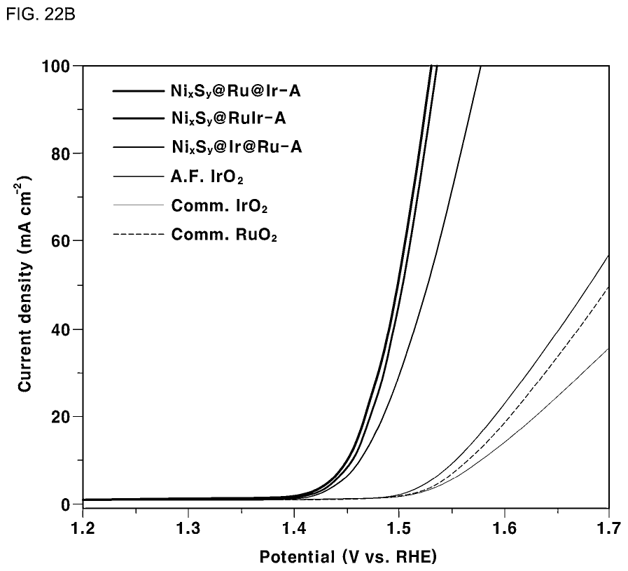

Here, OER was measured at 1,600 rpm using a 0.1 M HClO₄ solution. The voltage was converted from a reversible hydrogen electrode (RHE), and polarization curves obtained by correcting the resistance of the aqueous solution are shown in FIGS. 22A and 22B.

FIG. 22A shows OER polarization curves of electrodes manufactured using the anode catalysts (NiₓS_{y}@Ru@Ir-A, NiₓS_{y}@Ru—Ir-A, NiₓS_{y}@Ir@Ru-A) after thermal oxidation according to Examples and commercial catalysts. FIG. 22B shows OER polarization curves of electrodes manufactured using the anode catalysts (NiₓS_{y}@Ru@Ir, NiₓS_{y}@Ru—Ir, NiₓS_{y}@Ir@Ru) before thermal oxidation according to Examples and commercial catalysts. Here, the commercial catalysts that were used were IrO₂ prepared by the Adams fusion method, commercial IrO₂, and commercial RuO₂.

With reference to FIGS. 22A and 22B, the catalytic activity of all three catalysts was greatly increased after thermal oxidation. This is deemed to be because the formed iridium ruthenium-based oxides serve to increase the activity.

Also, the NiₓS_{y}@Ru—Ir-A catalyst according to the second embodiment in which the Ru—Ir alloy shell grew on the precursor showed a very low overvoltage of 194 mV at a current density of 10 mA/cm² after thermal oxidation.

On the other hand, the NiₓS_{y}@Ru@Ir-A catalyst according to the first embodiment and the NiₓS_{y}@Ir@Ru-A catalyst according to the third embodiment grown in the form of a core-shell on the precursor showed overvoltage values of 213 mV and 247 mV, respectively, at a current density of 10 mA/cm² after thermal oxidation.

Therefore, it can be confirmed that the OER performance is positively improved depending on the extent of mixing of iridium and ruthenium grown on the precursor.

In contrast, for the IrO₂ prepared by the Adams fusion method, commercial IrO₂, and commercial RuO₂ catalysts, the overvoltage values at 10 mA/cm² were measured to be 322 mV, 346 mV, and 332 mV, respectively.

Thus, the catalysts according to the embodiments of the present disclosure exhibited greatly improved OER performance. Therefore, it can be confirmed that, when two oxide species IrO₂ and RuO₂ were present together rather than separately, they greatly contributed to the improvement of OER performance.

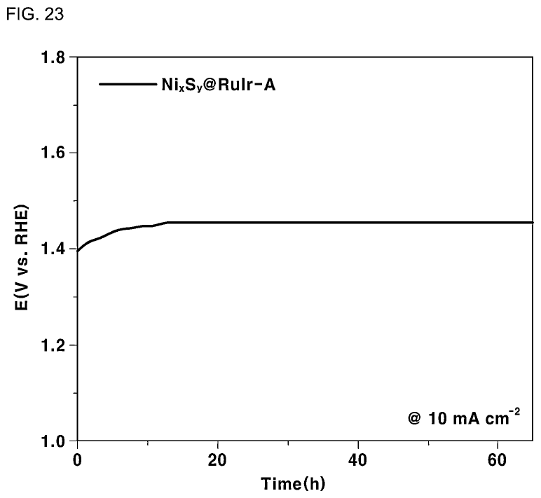

In addition, in order to confirm the durability of the NiₓS_{y}@Ru—Ir-A catalyst subjected to thermal oxidation according to Example 2 having the greatest activity among the prepared catalysts based on the above results, a chronopotentiometric test was performed at a current density of 10 mA/cm², and the results thereof are shown in FIG. 23. Here, the chronopotentiometric test was performed using a carbon paper electrode (CPE, 1 cm×1 cm) instead of GCE.

FIG. 23 shows a chronopotentiometric curve of the NiₓS_{y}@Ru—Ir-A catalyst subjected to thermal oxidation according to Example 2.

With reference to FIG. 23, the NiₓS_{y}@Ru—Ir-A catalyst having the greatest OER activity exhibited high durability even in the chronopotentiometric test measured at 10 mA/cm².

In addition, the NiₓS_{y}@Ru—Ir-A catalyst was slightly deteriorated after 60 hours compared to the initial voltage, but confirming that continuous oxygen evolution was possible.

### Test Example 6 (OER Active Cell Evaluation)

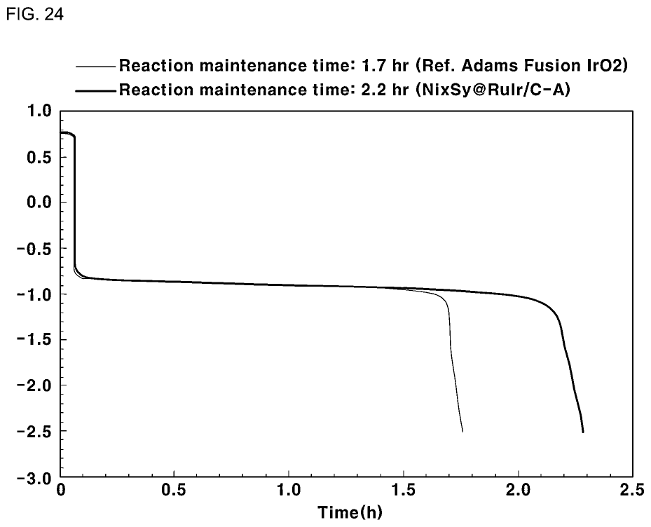

A membrane-electrode assembly was manufactured using the NiₓS_{y}@Ru—Ir-A catalyst according to the second embodiment in which the Ru—Ir alloy shell grew on the precursor having the greatest activity in the half-cell evaluation, and then oxygen evolution reaction was confirmed in the cell. The results of evaluation of the cell using the catalyst according to the second embodiment are shown in FIG. 24.

With reference to FIG. 24, in NiₓS_{y}@Ru—Ir-A having the greatest OER activity, oxygen evolution reaction could be continued for an about 1.3-fold long period of time compared to IrO₂ prepared by the Adams fusion method.

Therefore, in the present disclosure, the anode nanocatalyst in which the miscibility and composition distribution of iridium and ruthenium are controlled can provide high activity and stability in OER.

This is because the nanocatalyst prepared in the present disclosure has a structure in which small protrusions of the iridium ruthenium composition grow on the precursor, and the surface area of the catalyst is greatly increased, which can also contribute to improving OER catalytic performance.

Therefore, in the present disclosure, before iridium ruthenium-based iridium and ruthenium having a controlled composition at a nanoscale by the precursor grow on the precursor, iridium having relatively weak affinity to the precursor is pre-introduced into the precursor, thereby making it possible to control the metal miscibility in nanoparticles of the same composition.

In addition, the present disclosure is capable not only of increasing price competitiveness by reducing the amount of noble metal, but also of inducing in-situ doping of the precursor with the transition metal material through thermal oxidation and electrochemical oxidation during OER without separate solvothermal reaction.

Therefore, since the catalyst according to the present disclosure can be prepared in a large amount through solvothermal reaction using a solution including a metal precursor, it can be useful in a proton transfer membrane water electrolysis system and actual industry.

As is apparent from the above description, according to the present disclosure, it is possible to prepare an anode catalyst having high activity, high efficiency, and low overvoltage as well as long-term durability for oxygen evolution reaction (OER) in water electrolysis reaction.

In addition, in the present disclosure, OER catalytic performance can be improved by mixing ruthenium, which is relatively inexpensive and shows high OER performance, with iridium.

The effects of the present disclosure are not limited to the above-mentioned effects. It should be understood that the effects of the present disclosure include all effects that can be inferred from the description of the present disclosure.

Although specific embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. An oxygen evolution catalyst, comprising:
a core comprising nickel sulfide; and
a shell surrounding a surface of the core and comprising iridium oxide and ruthenium oxide.

2. The oxygen evolution catalyst of claim 1, wherein the core has a shape of a polyhedral prism.

3. The oxygen evolution catalyst of claim 1, wherein the shell comprises:
a first layer surrounding the core and comprising ruthenium oxide; and
a second layer surrounding the first layer and comprising iridium oxide.

4. The oxygen evolution catalyst of claim 1, wherein the shell is an alloy comprising an oxide of an alloy of iridium and ruthenium.

5. The oxygen evolution catalyst of claim 1, wherein the shell comprises:
a first layer surrounding the core and comprising iridium oxide; and
a second layer surrounding the first layer and comprising ruthenium oxide.

6. A fuel cell comprising the oxygen evolution catalyst of claim 1.

7. A method of preparing an oxygen evolution catalyst, comprising:
preparing a core comprising nickel sulfide;
manufacturing nanoparticles by allowing a coating layer comprising iridium and ruthenium to grow on a surface of the core; and
obtaining a catalyst by heat-treating the nanoparticles,
wherein the catalyst comprises the core and a shell surrounding a surface of the core and comprising iridium oxide and ruthenium oxide.

8. The method of claim 7, wherein preparing the core comprises:
preparing a first mixture by mixing a nickel precursor and a sulfide precursor;
forming a first reaction material by heat-treating the first mixture in an argon atmosphere; and
preparing a nickel sulfide precursor using centrifugation after addition of a solvent to the first reaction material.

9. The method of claim 8, wherein the nickel sulfide precursor has a shape of a polyhedral prism having a diameter of 10 to 15 nm and a length of 60 to 70 nm.

10. The method of claim 7, wherein preparing the core comprises:
preparing a first mixture by mixing a nickel precursor and a sulfide precursor;
forming a first reaction material by heat-treating the first mixture in an argon atmosphere;
preparing a second mixture by injecting an iridium precursor to the first reaction material;
forming a second reaction material by heat-treating the second mixture in an argon atmosphere; and
preparing a nickel sulfide precursor using centrifugation after addition of a solvent to the second reaction material.

11. The method of claim 10, wherein the nickel sulfide precursor has a shape of a polyhedral prism having a diameter of 15 to 20 nm and a length of 60 to 70 nm, a surface of which is doped with iridium.

12. The method of claim 8, wherein preparing the core comprises:
preparing a first mixture by mixing a nickel precursor and a sulfide precursor;
forming a first reaction material by heat-treating the first mixture in an argon atmosphere;
preparing an intermediate using centrifugation after addition of a solvent to the first reaction material;
preparing a third mixture by injecting an iridium precursor to the intermediate;
generating a third reaction material by heat-treating the third mixture in an argon atmosphere; and
preparing a nickel sulfide precursor using centrifugation after addition of a solvent to the third reaction material.

13. The method of claim 12, wherein the nickel sulfide precursor has a shape of a polyhedral prism having a diameter of 10 to 15 nm and a length of 60 to 70 nm, both ends of which are capped with iridium.

14. The method of claim 7, wherein manufacturing the nanoparticles comprises:
mixing the nickel sulfide precursor and at least one selected from the group consisting of an iridium precursor, a ruthenium precursor, and a combination thereof;
allowing iridium and ruthenium to grow on a surface of the nickel sulfide precursor by heat-treating a mixture in an argon atmosphere; and
manufacturing nanoparticles in powder form using centrifugation after addition of a solvent to a result after growth of iridium and ruthenium.

15. The method of claim 7, wherein obtaining the catalyst is performed for 30 minutes to 120 minutes under oxygen conditions at a temperature of 350 to 450° C.
